(19) United States
(12) Patent Application Publication
(10) Pub. No.: US 2021/0154969 A1
(43) Pub. Date: May 27, 2021

(54) COMPONENT FOR A VEHICLE AND METHOD FOR PRODUCING SUCH A COMPONENT

(71) Applicant: FORD GLOBAL TECHNOLOGIES, LLC, Dearborn, MI (US)

(72) Inventors: Thomas Baranowski, Würselen (DE); Maik Broda, Würselen (DE); Markus Franzen, Stolberg (DE); Pascal Rebmann, Frankfurt (DE)

(73) Assignee: FORD GLOBAL TECHNOLOGIES, LLC, Dearborn, MI (US)

(21) Appl. No.: 16/953,031

(22) Filed: Nov. 19, 2020

(30) Foreign Application Priority Data
Nov. 21, 2019 (DE) 102019131503.4

(51) Int. Cl. B32B 5/20; B32B 27/32

(52) U.S. Cl. CPC B32B 5/20; B29C 2035/0838; B32B 27/32

(57) ABSTRACT

A vehicle component (1) includes at least one dimensionally stable component base body (2) and at least one plastic layer (3) which is connected to at least one subregion of the component base body (2) in a materially bonded and areal manner and forms a surface portion of the component (1). In order to provide a component (1) which can be produced in a rapid and cost-effective manner and which has at least one customizable surface portion, the plastic layer (3) comprises a proportion of a thermally activatable foaming agent which is configured in such a way that a temperature for producing the plastic layer (3) is lower than a temperature for activating the foaming agent.

### CROSS-REFERENCE TO RELATED APPLICATIONS

This application claims foreign priority benefits under 35 U.S.C. § 119(a)-(d) to DE Application 10 2019 131 503.4 filed Nov. 21, 2019, which is hereby incorporated by reference in its entirety.

### TECHNICAL FIELD

The present application is directed to a vehicle component with a plastic layer including a foaming agent, and more particularly a thermally activatable foaming agent for forming design features on a vehicle component.

### BACKGROUND

Nowadays, buyers of passenger vehicles want to express a unique character by visually customizing their vehicles in various regions. Here, the trend is moving away from classic visual tuning using special retrofit components and toward customization solutions which are provided by original equipment manufacturers, such as, for example, wheels, headlamps, graphical items, body kits, decorative parts and the like. In particular, personalization of vehicles is a new trend in the automotive industry.

US 2006/0284330 A1 discloses a method for producing a composite trim component for a motor vehicle, wherein a flowable outer skin material is applied onto a first forming surface, a flowable carrier material is applied onto a second forming surface, a forming tool is closed and a foamable material is introduced into a gap between the flexible outer skin layer and the rigid substrate layer.

US 2003/0180498 A1 discloses a method for producing an outer skin for forming a visible front surface of an internal trim part, which comprises at least one prefabricated insert comprising a rear side which lies at a distance behind the visible front surface. The outer skin is produced by applying at least one flowable outer skin material for producing an elastomeric, non-cellular or microcellular plastics skin onto at least one surface of a mold and curing said flowable outer skin material. Prior to the connection of a structural carrier layer or of an intermediate foam layer to the rear side of the outer skin, the prefabricated insert is adhesively bonded to the outer skin material. Preference is given to using a reactive polyurethane mixture as flowable outer skin material. The prefabricated insert is preferably at least partially adhesively fixed as a result of the adhesion of the flowable outer skin material itself, before said material is completely cured.

U.S. Pat. No. 5,476,618 A discloses a resin laminate comprising a resin element composed substantially of a first resin material, a thermoplastic manufactured resin film composed of a second resin material, which originates from the group that can be blended with the aforementioned first resin material and which has a glass transition point which is lower than that of the aforementioned first resin material, and a foamed bead base composed substantially of the aforementioned first resin material. The foamed bead base, which is manufactured from a multiplicity of resin foaming beads, is arranged opposite the resin element. The thermoplastic resin film connects the resin element to the foamed bead base in an adhesive manner in that said resin film is melted and hardened again.

U.S. Pat. No. 6,713,522 B2 discloses a water-resistant, peelable foam coating composition which forms a protective and/or decorative coating and can adhere in a removable manner to a multiplicity of substrates. The coating has a three-dimensional expandable foam coating.

The publication “Innovation In Automotive Interior Materials and Processes”, which can be retrieved under the link https://wardsauto.informa.com/wp-content/uploads/Eller-ELLER-ASSOCIATES-Panel2.pdf, discloses a film which is produced by a combination of injection molding with IMG (in-mold graining).

The publication “NPE No. 3: Composites, Foaming, Hybrid Structures Get Traction”, which can be retrieved under the link http://www.themoldingblog.com/2018/04/11/npe-no-3-composites-foaming-hybrid-structures-get-traction/, discloses vehicle components produced in various ways.

### SUMMARY

The invention is based on the object of providing a component which can be produced in a rapid and cost-effective manner and which has at least one customizable surface portion.

According to the invention, the object is achieved by a component having the features of claim 1, the plastic layer of said component comprises a proportion of a thermally activatable foaming agent which is configured in such a way that a temperature for producing the plastic layer is lower than a temperature for activating the foaming agent.

It should be pointed out that the features and measures listed individually in the following description can be combined with one another in any technically expedient manner and show further configurations of the invention. The description additionally characterizes and specifies the invention in particular in connection with the FIGURE.

A component according to the invention for a vehicle, in particular a vehicle component, can be customized, for example personalized, to a great extent. To this end, the plastic layer of the component according to the invention must be subjected to merely local heat treatment, as a result of which a local chemical reaction of the foaming agent in the plastic layer is brought about, by which the foaming agent is locally thermally activated and foamed. The local foaming of the foaming agent leads to a local volume increase of the plastic layer. Since the component base body is configured to be more dimensionally stable than the plastic layer, during the local foaming of the foaming agent, a surface of the plastic layer, said surface facing away from the component base body, bulges locally away from the component base body in the region of the local volume increase, as a result of which the plastic layer obtains a visible, three-dimensional surface design which may resemble a conventional surface with sewn-on motif.

The plastic layer is produced from at least one plastics constituent and the foaming agent, and thus comprises a proportion of at least one plastics constituent in addition to the proportion of the foaming agent. The plastic layer can be of flexible or elastic configuration and is less dimensionally stable than the component base body. The plastic layer can for example be configured in the form of a plastics film. The plastic layer can for example form a surface portion of the component according to the invention, said surface portion being arranged so as to face a passenger compartment of the vehicle when the component is arranged as intended.

By virtue of the fact that the temperature for producing the plastic layer is lower than the temperature for activating the foaming agent, the foaming agent is not foamed already during the production of the plastic layer, such that a subsequent customization of the component according to the invention is possible as a result of a heat treatment. In this way, a customized component according to the invention can be produced in a rapid and cost-effective manner. The foaming of the foaming agent is also possible in a large variety of components according to the invention, for example in components in the form of lining components for lining a passenger compartment of the vehicle. Furthermore, during the foaming of the foaming agent, there are no limitations with respect to the respectively desired customization of the component according to the invention. The local heat treatment of the plastic layer can be affected for example by means of laser radiation or in some other way. The local heat treatment of the plastic layer makes it possible to form for example a name, a symbol, an image or the like on the surface of the plastic layer in a three-dimensional manner.

The component base body determines the essential shaping of the component according to the invention and gives the latter dimensional stability. In this case, the component base body is used to produce a robust connection between the component according to the invention and another vehicle component. The component base body can be produced from a plastic or a light-weight composite material. The component base body can be produced for example from a thermoplastic material. The component base body can be produced for example using an injection-molding process.

The component according to the invention can be a lining component for lining a vehicle interior, in particular passenger compartment, of the vehicle. By way of example, the component according to the invention can be configured in the form of an instrument panel, door trim, armrest, pillar trim, glove compartment flap or the like.

According to an advantageous configuration, the plastic layer comprises a polyvinyl chloride (PVC) or an olefin-based thermoplastic elastomer (TPO). In this way, the component can be provided with a desired surface quality.

A further advantageous configuration provides for the plastic layer to be adhesively bonded onto the component base body. In this way, a heat treatment is not required for attachment of the plastic layer to the component base body, such that the foaming agent of the plastic layer is not thermally activated as a result of the attachment of said plastics layer to the component base body. The component is thus customized only after the plastic layer has been attached to the component base body.

According to a further advantageous configuration, the foaming agent is foamed in certain regions in order to form at least one alphanumeric structure or at least one graphical item. The alphanumeric structure can for example be a name, a word or the like. The graphical item can for example be a symbol, an image or the like.

According to a further advantageous configuration, the component is a lining component for an interior of the vehicle. In this way, the interior, in particular the passenger compartment, of the vehicle can be customized or personalized by means of the component.

The object above is also achieved by a method having the features of Claim 6, according to which at least one plastics layer which forms a surface portion of the component is arranged on at least one subregion of the component base body in a materially bonded and areal manner, said plastics layer comprising a proportion of a thermally activatable foaming agent which is configured in such a way that a temperature for producing the plastic layer is lower than a temperature for activating the foaming agent.

The advantages mentioned above with respect to the component are correspondingly associated with the method. In particular, the component can be produced in accordance with one of the abovementioned configurations, or a combination of at least two of these configurations with one another, using the method.

According to an advantageous configuration, the plastic layer is produced partially from a polyvinyl chloride or an olefin-based thermoplastic elastomer. The advantages mentioned above with respect to the corresponding configuration of the component are correspondingly associated with this configuration.

A further advantageous configuration provides for the plastic layer to be adhesively bonded onto the component base body. The advantages mentioned above with respect to the corresponding configuration of the component are correspondingly associated with this configuration.

According to a further advantageous configuration, the foaming agent is foamed in certain regions in order to form at least one alphanumeric structure or at least one graphical item. The advantages mentioned above with respect to the corresponding configuration of the component are correspondingly associated with this configuration.

According to a further advantageous configuration, the foaming agent is foamed using laser beams. In this way, a very precise or local thermal treatment of the plastic layer is possible.

Further advantageous configurations of the invention are disclosed in the subclaims and the description of the FIGURE below.

### BRIEF DESCRIPTION OF THE DRAWINGS

FIG. 1 shows a schematic illustration of an exemplary embodiment for a component according to the invention, and for a method according to the invention for producing the component.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

The invention relates to a component for a vehicle, comprising at least one dimensionally stable component base body and at least one plastics layer which is connected to at least one subregion of the component base body in a materially bonded and areal manner and forms a surface portion of the component. The invention also relates to a method for producing a component for a vehicle, wherein a dimensionally stable component base body is produced.

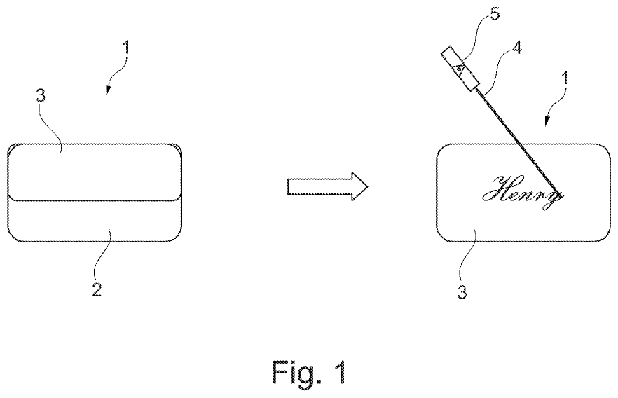

FIG. 1 shows a schematic illustration of an exemplary embodiment for a component 1 according to the invention and for a method according to the invention for producing the component 1.

The component 1 comprises a dimensionally stable component base body 2, which has been produced using a thermoplastic and an injection-molding process.

Furthermore, the component 1 comprises a plastics layer 3, which has been produced partially from a polyvinyl chloride or an olefin-based thermoplastic elastomer. The plastic layer 3 forms a surface portion of the component 1. The plastic layer 3 has been arranged on a subregion of the component base body 2 in a materially bonded and areal manner. In particular, the plastic layer 3 has been adhesively bonded onto the component base body 2. The plastic layer 3 comprises a proportion of a thermally activatable foaming agent (not shown) which is configured in such a way that a temperature for producing the plastic layer 3 is lower than a temperature for activating the foaming agent.

In the right-hand part of FIG. 1, the foaming agent is foamed in certain regions in order to form an alphanumeric structure in the form of a name by foaming the foaming agent using laser beams 4 of a movable laser 5.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

What is claimed is:

1. A vehicle component comprising:
at least one dimensionally stable component base body; and
at least one plastic layer connected to at least one subregion of the component base body in a materially bonded and areal manner such that the at least one plastic layer forms a surface portion of the vehicle component, the at least one plastic layer including a proportion of a thermally activatable foaming agent,
wherein a temperature for producing the at least one plastic layer is lower than an activation temperature for activating the foaming agent.

2. The vehicle component of claim 1, wherein the at least one plastics layer comprises a polyvinyl chloride or an olefin-based thermoplastic elastomer.

3. The vehicle component of claim 2, wherein the at least one plastics layer is adhesively bonded onto the component base body.

4. The vehicle component of claim 1, wherein the foaming agent is foamed in certain regions to form at least one alphanumeric structure or at least one graphical item on the vehicle component.

5. The vehicle component of claim 1, wherein the vehicle component is a lining component for a vehicle interior.

6. The vehicle component of claim 1, wherein the at least one plastics layer is adhesively bonded onto the component base body.

7. A method for producing a component for a vehicle comprising:
producing a dimensionally stable component base body;
producing at least one plastic layer including a proportion of thermally activable foaming agent; and
arranging the at least one plastic layer on at least one subregion of the component base body to form a surface portion of the component in a materially bonded and areal manner,
wherein a temperature for producing the at least one plastic layer is lower than a temperature for activating the foaming agent such that the at least one plastic layer is produced without foaming the foaming agent.

8. The method of claim 7, further comprising producing the at least one plastic layer partially from a polyvinyl chloride or an olefin-based thermoplastic elastomer.

9. The method of claim 7, further comprising adhesively bonding the at least one plastic layer onto the component base body.

10. The method of claim 7, further comprising foaming the foaming agent in certain regions to form at least one alphanumeric structure or at least one graphical item on the surface portion.

11. The method of claim 10, wherein the foaming agent is foamed using laser beams.

12. The method of claim 10, wherein the foaming is done subsequent to the arranging the at least one plastic layer.

13. A vehicle component comprising:
at least one component base body; and
at least one plastic layer including a proportion of a thermally activatable foaming agent, the at least one plastic layer being arranged on and connected to at least one subregion of the component base body in a materially bonded and areal manner such that the at least one plastic layer forms a surface portion of the vehicle component, the surface portion having certain regions foamed to define at least one alphanumeric structure or at least one graphical item on the vehicle component,
wherein a temperature for producing the at least one plastic layer is lower than an activation temperature for activating the foaming agent.

14. The vehicle component of claim 13, wherein the at least one plastic layer further includes a polyvinyl chloride or an olefin-based thermoplastic elastomer.

15. The vehicle component of claim 13, wherein the at least one plastic layer is adhesively bonded onto the component base body.
